(19) United States
(12) Patent Application Publication
(10) Pub. No.: US 2026/0122690 A1
(43) Pub. Date: Apr. 30, 2026

(54) A METHOD FOR PERFORMING RANDOM ACCESS BETWEEN A USER EQUIPMENT AND A NETWORK NODE IN A WIRELESS COMMUNICATION NETWORK

(71) Applicant: Continental Automotive Technologies GmbH, Hannover (DE)

(72) Inventors: Rikin Shah, Langen (DE); David Gonzalez Gonzalez, Egelsbach (DE)

(73) Assignee: Continental Automotive Technologies GmbH, Hannover (DE)

(21) Appl. No.: 19/117,195

(22) PCT Filed: Sep. 25, 2023
(86) PCT No.: PCT/EP2023/076319

§ 371 Date: Mar. 31, 2025

(30) Foreign Application Priority Data
Sep. 30, 2022 (DE) 10 2022 210 382.3

(51) Int. Cl. H04W 74/0833; H04W 24/08

(52) U.S. Cl. CPC H04W 74/0833; H04W 24/08

(57) ABSTRACT

Random access is performed between a user equipment and a network node in a wireless communication network. A random access preamble is transmitted to the base station. A random access response is received. A contention resolution message is transmitted. At least one discontinuous monitoring cycle is configured on a downlink channel for receiving a response to the transmitted contention resolution message And a content resolution message is received during an active period of the discontinuous monitoring cycle. The disclosure also relates to an apparatus configured to implement said method.

### CROSS-REFERENCE TO RELATED APPLICATIONS

The present application is a National Stage Application under 35 U.S. C. § 371 of International Patent Application No. PCT/EP2023/076319 filed on Sep. 25, 2023, and claims priority from German Patent Application No. 10 2022 210 382.3 filed on Sep. 30, 2022, in the German Patent and Trademark Office, the disclosures of which are herein incorporated by reference in their entireties.

### TECHNICAL FIELD

The following relates generally to wireless communications, and more particularly to a method for performing contention-based random access in a wireless communication system.

### BACKGROUND

Wireless communication systems are widely deployed to provide various types of communication content such as voice, video, packet data, messaging, broadcast, and so on.

A wireless multiple-access communication system may include a number of base stations, each supporting communication for multiple mobile devices simultaneously. A base station may communicate with UEs on downstream and upstream links. Each base station has a coverage range, sometimes referred to as a cell coverage area.

Non-Terrestrial Networks (NTN) has become an umbrella term for any network that involves non-terrestrial flying objects, like satellites communication networks or High-Altitude Platforms Systems (HAPS) including airplanes, balloons and airships.

Satellite communication networks rely on spaceborne platforms comprising Low Earth orbiting (LEO) satellites, Medium Earth Orbiting (MEO) satellites, and geosynchronous Earth orbiting (GEO) satellites.

Nowadays, there is a growing interest in the broadband supported by LEO NTNs, with large satellites constellations. The satellite industry is now committed in the 3GPP process to integrate satellite networks into the 5G ecosystem.

The integration of Non-Terrestrial Networks (NTNs) within the 5G framework is under standardization and can lead to manifold advantages, such as wide service coverage capabilities (5G services for underserved areas), reduced vulnerability of space/airborne vehicles to physical attacks and natural disasters, reinforced service reliability (service continuity for M2M/IoT devices or for passengers on board moving platforms, e.g., aircrafts or vessels, backup link), efficient multicast/broadcast for data delivery towards the network edges or even user terminals.

However, NTN integration is also leading to challenges related to the employment and adaptation to aerospace networks of technologies originally designed for terrestrial networks.

In particular, a UE communicating with a NTN base station will experience a high Round Trip time (RTT) compared to traditional terrestrial communications what leads to increased power consumption.

Whenever a UE needs to access a wireless network, it usually performs a so-called Random Access procedure (RA). RA is used to achieve Uplink (UL) Synchronization and Radio Resource Control (RRC) connection, for example upon initial network access, RRC connection reestablishment or handover.

Two types of Random access procedure can be distinguished: contention-based random access procedure and a contention-free based random access procedure.

FIG. 2 shows an example of messages that may be exchanged between a UE and a base station (gNB) during a contention-based random access procedure. When performing RA, a UE transmits a random access preamble to a base station using a first message (MSG1). In case of contention-based RA, the preamble is randomly selected by UE from a predefined set of preambles shared with other UEs, whereas in contention-free RA, the preamble is allocated to the UE by a base station (dedicated preamble).

After sending the preamble, the UE monitors the PDCCH and waits for a RA response (MSG2) within a response window (RARW).

Upon receiving a preamble, the base station transmits a RA response (MSG2) to the UE over PDSCH (Physical Downlink Shared Channel). The response contains a RA-preamble identifier, timing alignment information, an uplink grant allowing UE to send MSG3, and temporary C-RNTI (Cell-Radio Network Temporary Identifier).

When the UE receives a response including a preamble identifier that correspond to the preamble transmitted in MSG1, it transmits uplink (UL) scheduling information (MSG3). Otherwise, RA fails and a UE may perform a new RA attempts.

After sending MSG3, UE starts a Contention Resolution (CR) timer (CRT) and keeps monitoring on the PDCCH until CR timer expires. Finally, random access succeeds when UE receives a contention resolution messages (MSG4) before expiration of CR Timer (CRT).

In case of NTN communication, a long Round Time Trip (RTT) may be experienced between UE and base station. In order to avoid contention resolution failure in such long RTT situations, UE might need to extend CR timer. However, this would also increase power consumption for UE, since the PDCCH monitoring period would also be increased.

A shown on FIG. 3, 3GPP proposed to delay the starting of CR Timer based on RTT value. FIG. 3 shows a content resolution message exchange between a UE and a NTN base station wherein the start of CR Timer is delayed based on RTT value. More precisely, UE starts a RTT timer upon Msg3 transmission and starts CR Timer only after expiration of said RTT timer. This way, UE may save power, the monitoring on DL channel (depicted by the “ON” block on FIG. 2) being started only after the RTT period expired.

Event if such a method avoids useless monitoring on DL channel during message round trip period, while no message is expected to be received, and thus avoid a waste of power, a problem may arise when blind message retransmission is implemented.

In order to improve the coverage in such large RTT conditions, 3GPP contemplates blind retransmission of Msg3, which enables a base station to schedule Msg3 retransmission blindly during UE-base station round-trip time. As used herein, “blind retransmission” may generally refer to a retransmission scheme in which a transmitting device blindly performs one or more retransmissions for a transmission without receiving any feedback from a receiving device.

FIG. 4 is a partial message flow showing contention resolution messages that could be exchanged during a random access procedure performed by a UE accessing a NTN base station involving blind Msg3 retransmissions. In such conditions, the CR Timer would expire upon receiving PDCCH indicating Msg3 retransmission and UE will consider contention resolution as unsuccessful, even is Msg4 would arrive later. Indeed, upon retransmission of Msg3 (MSG3 RTX), the CR timer would restart only after expiration of delay based on RTT.

In order to avoid contention resolution failure, UE might need to extend CR timer which would increase power consumption for IoT UE.

There is therefore a need for a method that would allow blind retransmission during a random access procedure between a UE and a NTN base station that would prevent power waste.

### BRIEF SUMMARY

It is therefore an object of the present disclosure to provide a method and an apparatus for performing a Random Access Procedure that reduces UE's power consumption during Contention Resolution.

An aspect of the present disclosure relates to a method performed by a user equipment for random access procedure between said user equipment and a network node in a wireless network, the method comprising:
transmitting a random access preamble to said network node,
receiving a random access response,
transmitting a contention resolution message,
configuring at least one discontinuous monitoring cycle on a downlink channel for receiving a response to said transmitted contention resolution message, and
receiving a content resolution message during an active period of said discontinuous monitoring cycle.

Discontinuous reception allows the UE to periodically switch from a sleeping state to an active state according to a predefined or dynamically configured timing pattern. By monitoring on PDCCH discontinuously, the method makes it possible to extend the contention resolution timer duration (and associated PDCCH monitoring) without increasing power consumption. This way, UE may handle properly blind Msg3 retransmissions in a power-efficient way.

According to an embodiment, discontinuous monitoring is configured based on a configuration received from said network node.

The scheduling of the on/off period is configured by the network node, e.g. a base station. It is therefore possible for the base station to known when PDCCH monitoring will be active on UE side and schedule the transmission of a contention resolution message accordingly.

According to an embodiment, discontinuous monitoring configuration is received in a system information message.

A base station may transmit the on/off scheduling in a System Information Block (SIB) along with other configuration parameters. Because System information is cell-specific, all UE within a can read same information through one signaling. Signaling overhead is therefore reduced.

According to an embodiment, discontinuous monitoring configuration is received in a Random Access Response comprising Msg3 retransmission uplink grant.

Discontinuous monitoring configuration may thus be transmitted by a base station along with a Msg3 retransmission uplink (UL) grant, for example in a Msg2 or Random Access Response (RAR) message. Hence, a base station may adjust the discontinuous monitoring timing dynamically based on network conditions experienced during previous messages exchange, what is particularly advantageous since NTN base stations are moving at high speed, occasioning frequent changes in signal propagation delay.

According to an embodiment, discontinuous monitoring configuration is received in both a a Random Access Response comprising a Msg3 retransmission grant and system information message.

It is also contemplated that discontinuous monitoring configuration may be transmitted in both SIB and RAR. Thus, a default configuration transmitted in system information may be later updated to better correspond to the network conditions experienced by UE and network node.

According to an embodiment, discontinuous monitoring on downlink channel cycle is performed while a contention resolution timer is running.

Network reduces UE's monitoring time by configuring ON-OFF period within a Contention Resolution Timer.

According to an embodiment, discontinuous monitoring on downlink channel is performed from the expiration of a first contention resolution timer associated with a transmission of a first Msg3 message and the start of a second contention resolution timer associated with the retransmission of said Msg3 message.

The CR timer is thus extended until a retransmission CR timer is started. The power consumption is mitigated during the extended CR timer period by configuring discontinuous PDCCH monitoring.

According to another aspect of the disclosure, it is contemplated an apparatus for performing random access between said apparatus and a base station in a wireless communication network, the apparatus comprising a processor coupled with a memory comprising computer program instructions stored thereon, said instructions being configured to implement steps of:
transmitting a random access preamble to said base station,
receiving a random access response,
transmitting a contention resolution message,
configuring at least one discontinuous monitoring cycle on a downlink channel for receiving a response to said transmitted contention resolution message, and
receiving a content resolution message.

In some embodiments, the various steps of the method for performing random access by a user equipment are determined computer program instructions.

Consequently, the disclosure further contemplates a computer program on an information medium, said program being suitable to be implemented in user equipment device, or more generally in a computer, said program comprising instructions adapted to implement the steps of the method for performing random access procedure disclosed herein.

The program can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being arranged to execute or to be used in the execution of the method for performing random access.

The advantages of apparatus, user equipment, computer program and information medium are identical to those presented in relation with the method for performing random access according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 is a schematic diagram of a NTN wireless communication system suitable to implement the method for random access procedure disclosed herein, according to an embodiment.

FIG. 2 is a sequence chart showing messages exchanged for contention-based random-access procedure.

FIG. 3 is a sequence chart showing contention resolution messages between a UE and a NTN base station.

FIG. 4 is sequence chart showing a contention resolution message exchange between a UE and a NTN base station involving blind Msg3 retransmission.

FIG. 5 is a flow chart illustrating main steps of the method for random access procedure disclosed herein, according to an embodiment.

FIG. 6 is sequence chart illustrating contention resolution messages between a UE and a base station involving blind Msg3 retransmission, according to a first embodiment.

FIG. 7 is sequence chart illustrating contention resolution messages between a UE and a base station involving blind Msg3 retransmission, according to a second embodiment.

FIG. 8 shows a schematic architecture of an apparatus for performing random access procedure in a wireless network, according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

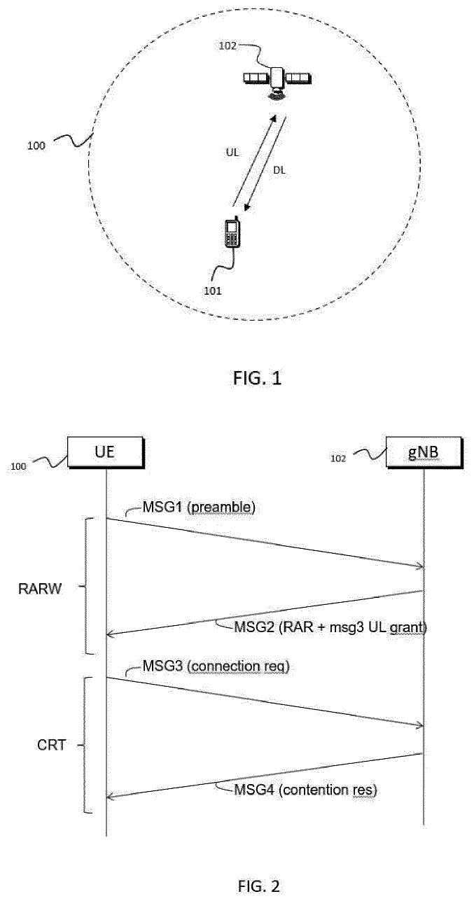

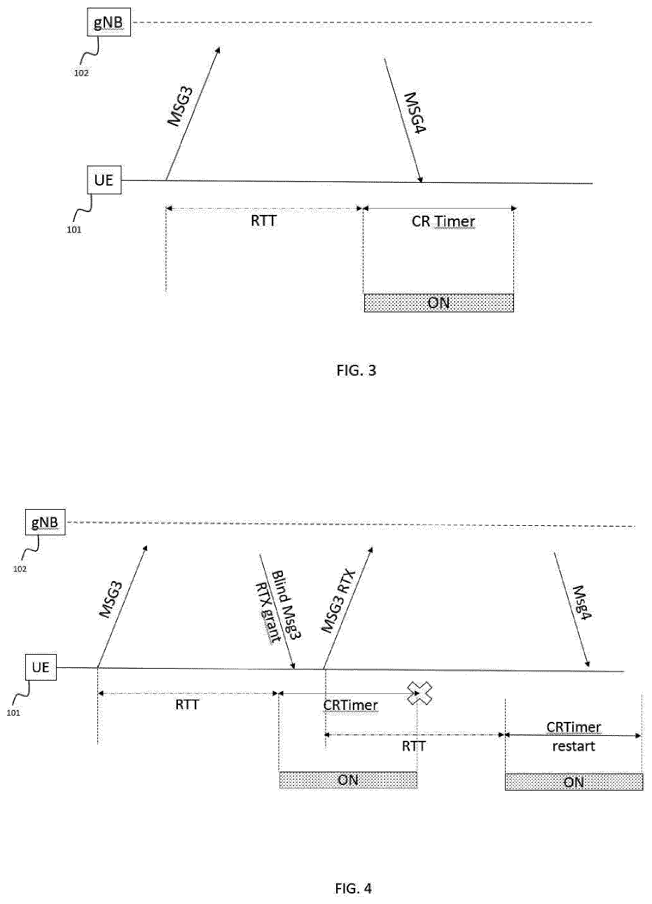

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as LTE, 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provide radio communication coverage for a particular geographic area called “cell”.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

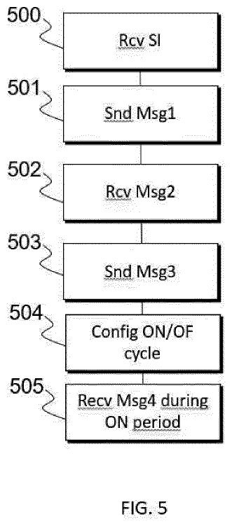

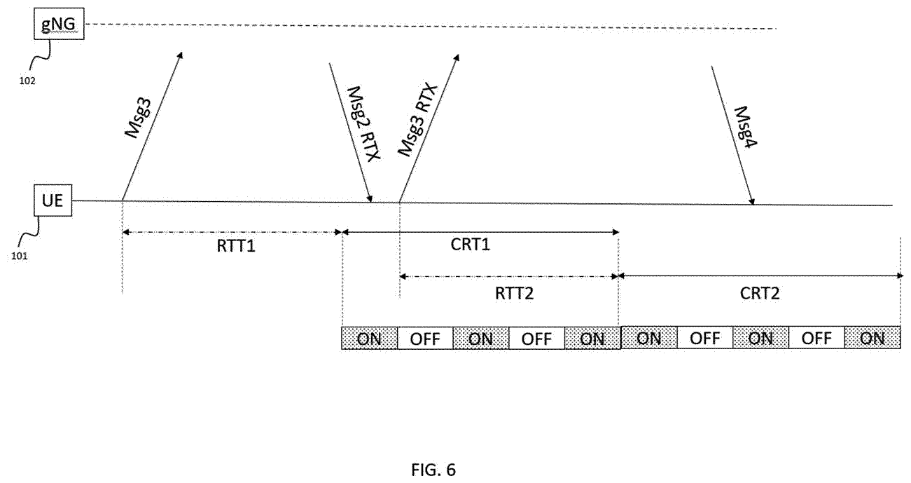

A first embodiment of a method for performing power efficient random access in a wireless NTN network will now be described with reference to FIG. 5 and FIG. 6.

FIG. 5 is a flowchart showing main steps of a method for performing random access according to an embodiment.

During a first step 500, the user equipment 101 shown on FIG. 1 may receive a system information block (SIB) periodically broadcasted by base station 102. According to an embodiment, said system information may include parameters for configuring discontinuous monitoring of PDCCH. In some embodiments, said parameters may comprise a duration of discontinuous reception cycle (i.e., sleep state duration+active monitoring state duration), and/or a duration of the active state (“ON”), and/or a duration of an inactive state (“OFF”), and/or a duration of the discontinuous monitoring period.

The present disclosure contemplates that said parameters included in system information may further comprise an indication, for example a single bit, used to indicate whether the discontinuous ON/OFF monitoring period starts with an “ON” period first or with an “OFF” period first. In some example, said bit is set to indicate that discontinuous reception cycle shall start by an active reception period.

At step 501, in order to establish downlink synchronization with the base station 102, UE 101 initiate a contention-based random access procedure by sending a Msg1 message comprising a RACH preamble randomly selected by UE.

At step 502, a Random Access Response (RAR, or Msg2) transmitted by the base station 102 is received by user equipment 101 within a time window. UE 101 may then decode the RAR message and start the radio resource control (RRC) process by first self-configuring and replying an RRC connection request (Msg3) for uplink scheduled transmission. The RAR message received in response to the random access preamble sent in step 501 may comprise a temporary C-RNTI, timing advance (TA), and uplink grant for L2/L3 message.

According to an embodiment, the RAR message (Msg2) received in step 502 may further comprise parameters for configuring discontinuous monitoring of PDCCH. According to an embodiment, said parameters received in RAR message may include parameters for configuring discontinuous monitoring of PDCCH. In some embodiments, said parameters may comprise a duration of an OFF+ON period (i.e., sleep state duration+active state duration), and/or a duration of the active state, and/or a duration of an inactive state, and/or a duration of the discontinuous monitoring period.

The present disclosure contemplates that said parameters included in system information may further comprise an indication, for example a single bit, used to indicate whether the discontinuous ON/OFF monitoring period starts with an “ON” period first or with an “OFF” period first.

Because multiple UEs may select a same preamble, collision may occur when sending RACH preamble (Msg1). In such case, UE may not receive the expected RAR message within its time window, and the PRACH preamble is retransmitted by UE after a back-off timer expires.

The method for performing random access may further comprise a step 503 during which UE sends uplink scheduling information (Msg3) to the base station over PUSCH (Physical Uplink Shared Channel).

Following the sending of uplink scheduling information (Msg3), UE may perform a step 504 during which is configures discontinuous monitoring on a physical downlink channel (i.e., PCDDH) based on parameters received in SIB and/or RAR messages. In some embodiment, the step of configuring discontinuous monitoring may comprise delaying the starting of a contention resolution timer until a delay based on EU-base station RTT value, has expired and starting said contention resolution timer after expiration of said delay based on RTT value. For example, a user equipment with pre-compensation capability may obtain UE specific UE-gNB RTT based on its GNSS (Global navigation satellite system) location in LEO/GEO.

According to an embodiment, discontinuous monitoring is started when contention resolution timer starts, and stops when contention resolution timer expires.

According to an embodiment, UE monitors on PDCCH continuously while CR timer is running, discontinuous monitoring being configured after CR timer expiration and stopped when CR timer is restarted.

The method further comprises a step 505 in which a contention resolution message (Msg4) is received during a “ON” duration period.

FIG. 6 shows a content resolution messages flow involving blind Msg3 retransmission between UE 101 and NTN base station 102 according to an embodiment. After receiving an Uplink grant for Msg3 (not shown on FIG. 6), UE 101 sends a first RRC connection request (Msg3) to the base station 102. Because of the large RTT between UE 101 and NTN base station 102, UE postpones the starting of the CR timer based on RTT1 value. Once CR Timer CR1 is started, UE 101 starts discontinuous monitoring on PDCCH in order to receive blind retransmission and/or Msg4. Discontinuous monitoring may be configured based on a configuration received in System Information and/or Msg2 message as detailed hereinabove. Accordingly, when “OFF duration” expires, UE starts an active monitoring period “ON duration” during which UE 101 stays awake and monitor UL grant (PDCCH) for blind retransmission and Msg4. When “ON duration” expires, UE starts “OFF duration” during which UE 101 does not monitor any PDCCH. FIG. 4 further shows UE 101 receiving a Msg2 retransmission during “ON duration” comprising a bling Msg3 retransmission grant (Msg2 RTX) while contention resolution timer CRT1 is running. The receiving of Msg2 RTX message by UE 101 triggers the sending of a Msg3 message retransmission (Msg3 RTX) by UE 101. Upon sending Msg3 retransmission (Msg3 RTX), UE 101 schedule a delayed starting of a new content resolution timer CRT2, said starting of timer CRT2 being delayed based on a RTT value. Therefore, the starting of timer CRT2 is scheduled after the expiration of a RTT2 period. To avoid any gap between the expiration of CRT1 monitoring period and the start of timer CRT2, CRT1 timer duration and associated discontinuous monitoring is extended until CRT2 timer starts. This way, a longer CR timer can be configured without increasing UE's power consumption, making it possible to receive a possible Msg4 arriving later.

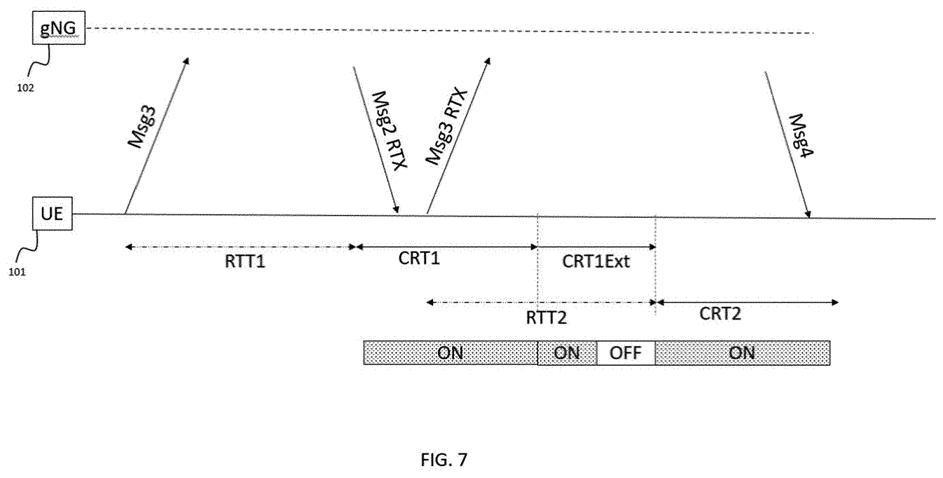

FIG. 7 shows a content resolution messages flow involving blind Msg3 retransmission between UE 101 and NTN base station 102 according to another embodiment. After receiving an uplink grant for Msg3 (not shown on FIG. 7), UE 101 sends a first RRC connection request (Msg3) to the base station 102. Because of the large RTT between UE 101 and NTN base station 102, UE delays the starting of the CR timer based on RTT1 value. Once CR Timer CRT1 is started, UE 101 starts a continuous monitoring on PDCCH until CRT1 expires. FIG. 7 further shows a blind Msg3 retransmission grant (Msg2 RTX) received by UE 101 while timer CRT1 is running. The reception of said blind Msg3 retransmission grant by UE 101 triggers the sending of a Msg3 retransmission upon which the starting of a new content resolution timer (CRT2) is scheduled after expiration of a delay (RTT2) based on UE-gNB RTT. In order to avoid expiration of CRT1 timer before RTT2 delay lapsed, what could lead to UE considering contention resolution failure, CRT1 timer is extended (CRT1Ext) until contention resolution timer is restarted (CRT2). During CRT1 timer extension, UE 101 performs discontinuous monitoring on PDCCH instead of continuous monitoring in order to limit power consumption. Hence, discontinuous monitoring period starts after expiration of a contention resolution timer and ends before a contention resolution timer is restarted following a retransmission. This way, a longer CR timer can be configured without increasing UE's power consumption, making it possible to receive a possible Msg4 arriving later.

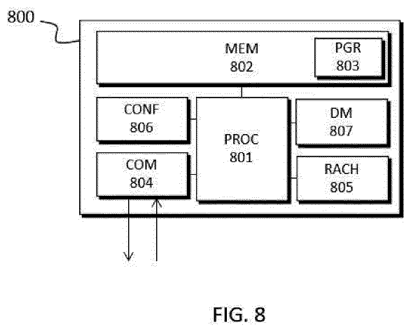

FIG. 8 shows a schematic architecture of an apparatus 800 suitable to implement a method for performing random access procedure between said apparatus 800 and a base station in a wireless communication network, according to an embodiment.

The apparatus 800 comprises a processor 801 and a memory 802, for example a Random Access Memory (RAM). The processor 801 may be controlled by a computer program 803 stored in the memory 802 comprising instructions configured to implement a method for performing random access in a wireless network between said apparatus and a network node, according to a particular embodiment.

More precisely, the computer program 803 comprises instructions to implement steps of transmitting a random access preamble to a network node, receiving a random access response, transmitting a contention resolution message, configuring a discontinuous monitoring on a downlink channel for receiving a response to said transmitted contention resolution message, and receiving a content resolution message.

On initialization, the instructions of the computer program 803 may be loaded into the memory 802 before being executed by the processor 801. The processor 801 implements the steps of the method according to the instructions of the computer program 803.

The apparatus 800 comprises a wireless transceiver unit 804 that may be configured by the processor 801 to establish radio communication with other devices. As an example, the wireless transceiver 804 may be a 5G NR compliant transceiver suitable to establish communication with a 5G NR non-terrestrial access network. The transceiver unit 804 may be configured by program instructions of the computer program 803 to receive a system information block from a serving base stations and exchange messages with said base station.

The apparatus 800 may further comprise a RACH unit 805. The RACH unit 805 may be implemented by computer program instructions configured to implement steps of a contention-based random access procedure in order to achieve uplink synchronization between said apparatus 800 and a base station. The RACH unit 805 may be further configured to support blind Msg3 retransmission.

The apparatus 800 may also comprise a discontinuous reception configuration unit 806. The configuration unit 806 may be implemented by computer program instructions configured to obtain discontinuous reception configuration parameters from a system information block broadcasted by a network node. In some embodiments, said discontinuous reception configuration parameters may include discontinuous reception cycle duration, and/or inactive state duration and/or inactive state duration and/or a flag indicating whether the discontinuous reception cycle should begin with an active period or an inactive period. The discontinuous reception configuration unit 806 may be further configured to obtain configuration parameters from a Msg3 retransmission grant received by the communication unit 804.

Finally, the apparatus 800 may comprise a discontinuous reception unit 807 configured to discontinuously monitor on a downlink channel, e.g. on PDCCH, for reception of a blind Msg3 retransmission and/or Msg4 message. According to an embodiment, the discontinuous reception unit 807 may be configured by the discontinuous reception configuration unit 806 to perform at least one discontinuously monitoring cycle on PDCCH comprising an ON duration period (e.g., active reception state) and an OFF duration period (e.g., inactive reception state) while a contention timer is running. In some embodiment, discontinuous monitoring is maintained during the whole contention timer duration. According to an embodiment, the discontinuous reception unit 807 may be configured by the discontinuous reception configuration unit 806 to perform continuous monitoring on PDCCH during an initial duration of a contention resolution timer triggered by a first transmission of a Msg3, to perform discontinuous monitoring on PDCCH during an extended duration of said contention resolution timer, and to stop discontinuous monitoring on PDCCH when a contention resolution timer is restated due to a Msg3 retransmission.

The present disclosure also contemplates a user equipment device comprising such an apparatus 800 and a wireless system comprising said user equipment.

1. A method of wireless communication by a user equipment for random access procedure between said user equipment and a network node in a wireless communication network, the method comprising:
transmitting a random access preamble to said base station,
receiving a random access response,
transmitting a contention resolution message,
configuring at least one discontinuous monitoring cycle on a downlink channel for receiving a response to said transmitted contention resolution message, and
receiving a content resolution message during an active period of said discontinuous monitoring cycle.

2. The method according to claim 1 wherein discontinuous monitoring is configured based on a configuration received from said network node.

3. The method according to claim 2 wherein discontinuous monitoring configuration is received in a system information message.

4. The method according to claim 2 wherein discontinuous monitoring configuration is received in a Random access Response message comprising Msg3 retransmission uplink grant.

5. The method according to claim 2 wherein discontinuous monitoring configuration is received in both a Random access Response message comprising a Msg3 retransmission grant, and system information message.

6. The method according to claim 1 wherein discontinuous monitoring on downlink channel cycle is performed while a contention resolution timer is running.

7. The method according to claim 1 wherein discontinuous monitoring on downlink channel is performed from the expiration of a first contention resolution timer associated with a transmission of a first Msg3 message and the start of a second contention resolution timer associated with the retransmission of said Msg3 message.

8. An apparatus for performing random access between said apparatus and a network node in a wireless communication network, the apparatus comprising a processor coupled with a non-transitory memory comprising computer program instructions stored thereon, said instructions being configured to perform operations comprising:
transmitting a random access preamble to said network node,
receiving a random access response,
transmitting a contention resolution message,
configuring at least one discontinuous monitoring cycle on a downlink channel for receiving a response to said transmitted contention resolution message, and
receiving a content resolution message.

9. The apparatus according to claim 8, wherein the apparatus is a user equipment.

10. A wireless communication system comprising a user equipment for performing random access between an apparatus and a network node in a wireless communication network, the apparatus comprising a processor coupled with a non-transitory memory comprising computer program instructions stored thereon, said instructions being configured to perform operations comprising:
transmitting a random access preamble to said network node,
receiving a random access response,
transmitting a contention resolution message,
configuring at least one discontinuous monitoring cycle on a downlink channel for receiving a response to said transmitted contention resolution message, and
receiving a content resolution message.

11. (canceled)

12. A non-transitory computer-readable information medium comprising computer-executable instructions for performing wireless communication by a user equipment for random access procedure between said user equipment and a network node in a wireless communication network, by performing operations comprising:
transmitting a random access preamble to said base station,
receiving a random access response,
transmitting a contention resolution message,
configuring at least one discontinuous monitoring cycle on a downlink channel for receiving a response to said transmitted contention resolution message, and
receiving a content resolution message during an active period of said discontinuous monitoring cycle.
